(19) United States
(12) Patent Application Publication
(10) Pub. No.: US 2026/0185886 A1
(43) Pub. Date: Jul. 2, 2026

(54) DIGITAL PRESSURE GAUGE

(71) Applicant: MAT INDUSTRIES, LLC, Long Grove, IL (US)

(72) Inventor: Mitchell Dean MILLER, Decaturville, TN (US)

(21) Appl. No.: 19/381,420

(22) Filed: Nov. 6, 2025

Related U.S. Application Data
(60) Provisional application No. 63/739,150, filed on Dec. 27, 2024.

(51) Int. Cl. G01L 19/08; G01L 19/00; G09G 3/32; G09G 3/34

(52) U.S. Cl. CPC G01L 19/083; G01L 19/0038; G09G 3/32; G09G 3/3406; G09G 2330/022; G09G 2330/026; G09G 2330/027; G09G 2354/00

(57) ABSTRACT

A digital pressure gauge is provided, the digital pressure gauge including a housing with an inlet port configured to receive air from a source of air, a pressure sensor which measures a pressure value of the air at the inlet, a digital display which displays the pressure value, the digital display including an LED display and a backlight which illuminates the LED display, a vibration sensor which detects a vibration experienced by the housing, an on/off button which turns the digital display on and off, and electronic circuitry which communicates with a processor within the housing and which is electrically connected to the digital display, the pressure sensor, the on/off button, and the vibration sensor, the electronic circuitry being configured to execute a backlight deactivation protocol.

### BACKGROUND

The present invention generally relates to digital pressure gauges, and more specifically to digital pressure gauges used with air compressor systems.

Conventional digital pressure gauges often operate from power provided by disposable batteries, such as watch batteries. However, these disposable batteries often have limited energy stored within the battery, and often provide limited operation time for the digital pressure gauge. Additionally, conventional digital pressure gauges often consume a significant amount of energy in operation.

Accordingly, there remains a need for an improved digital pressure gauge which addresses the above listed deficiencies.

### SUMMARY

The above-listed need is met or exceeded by the present digital pressure gauge. In particular, the present digital pressure gauge includes electronic circuitry which activates and deactivates an LED display and a backlight of a digital display of the digital pressure gauge. The digital pressure gauge also includes a vibration sensor, preferably in the form of a g-sensor, which detects a vibration experienced by the digital pressure gauge, which is optionally caused by operation of a compressor connected to the digital pressure gauge.

Detected vibrations are registered by the vibration sensor and are relayed to a processor associated with the electronic circuitry, such that the processor causes the electronic circuitry to activate at least one of the backlight and the LED display based on the registered vibration or an actuation of an on/off button. Additionally, the electronic circuitry is configured to execute a backlight deactivation protocol, to help reduce power consumption of the digital pressure gauge.

The backlight deactivation protocol preferably includes monitoring whether the backlight has remained on for a predetermined backlight time period, and deactivating the backlight when the backlight has been on for the predetermined backlight time period. When the backlight has remained on for a period of time less than the predetermined backlight time period, the backlight deactivation protocol includes an activation detection step, where the electronic circuitry detects whether an activation has occurred. Preferably, the activation includes either a registered vibration or an actuation of the on/off button. By deactivating the backlight, the digital pressure gauge preferably reduces power consumption.

The electronic circuitry preferably executes an LED deactivation protocol which includes monitoring whether the LED display has remained on for a predetermined LED display time period and deactivating the LED display when the LED display has been on, and no vibration is detected, for the predetermined LED display time period. By deactivating the LED display, the digital pressure gauge preferably further reduces power consumption. In this way, the digital pressure gauge preferably has greater operating life due to efficient power consumption.

More specifically, a digital pressure gauge is provided, the digital pressure gauge including a housing with an inlet port configured to receive air from a source of air, a pressure sensor which measures a pressure value of the air at the inlet, a digital display which displays the pressure value, the digital display including an LED display and a backlight which illuminates the LED display, a vibration sensor which detects a vibration experienced by the housing, an on/off button which turns the digital display on and off, and electronic circuitry which communicates with a processor within the housing and which is electrically connected to the digital display, the pressure sensor, the on/off button, and the vibration sensor, the electronic circuitry being configured to execute a backlight deactivation protocol.

In a preferred embodiment, the backlight deactivation protocol includes measuring the pressure value with the pressure sensor, displaying the measured pressure value on the digital display, and determining whether the backlight has remained on for a predetermined backlight time period, such that the backlight is deactivated when the backlight has remained on for the predetermined backlight time period. Preferably still, the backlight deactivation protocol also includes detecting whether an activation has occurred when the backlight has remained on for a period of time less than the predetermined backlight time period, such that the electronic circuitry measures the pressure value when the activation is detected. Preferably, the activation includes either detection by the vibration sensor of the vibration experience by the housing, or actuation of the on/off button.

In another preferred embedment, the electronic circuitry is configured to execute an LED deactivation protocol which includes monitoring whether the LED display has remained on for a predetermined LED display time period and whether a vibration has been detected, such that when the LED display has remained on for a period of time less than the predetermined LED display time period, the electronic circuitry executes the LED display deactivation protocol, and when the LED display has remained on for the predetermined LED display time period, and no vibration is detected, the LED display is deactivated. Preferably still, the LED deactivation protocol also includes periodically monitoring for the activation at intervals of a predetermined idle time period, such that when the activation does not occur within the predetermined idle time period, the LED remains deactivated, and when the activation does occur, the LED display is activated.

In preferred embodiments, the predetermined LED display time period is greater than the predetermined backlight time period, and the predetermined LED display time period is greater than the predetermined idle time period.

In additional preferred embodiments, the digital pressure gauge includes a disposable battery within the housing which powers the LED display, the backlight, the processor, and the electronic circuitry, and the digital pressure gauge includes an auxiliary button which changes a unit system displayed on the digital display.

A second embodiment of the present disclosure includes a compressor system with a compressor which produces pressurized air, and a digital pressure gauge. The digital pressure gauge includes a housing with an inlet port configured to receive air from the compressor, a pressure sensor which measures a pressure value of the air at the inlet, a digital display which displays the pressure value, the digital display including an LED display and a backlight which illuminates the LED display, a vibration sensor which detects a vibration experienced by the housing, an on/off button which turns the digital display on and off, and electronic circuitry which communicates with a processor within the housing and which is electrically connected to the digital display, the pressure sensor, the on/off button, and the vibration sensor, such that the electronic circuitry is configured to execute a backlight deactivation protocol.

### BRIEF DESCRIPTION OF THE DRAWINGS

FIG. 1 is a front exploded perspective view of the present digital pressure gauge;

FIG. 2 is a front plan view of the digital pressure gauge shown in FIG. 1;

FIG. 3 is a schematic diagram illustrating the components of the digital pressure gauge of FIG. 1;

FIG. 4 is a flow chart illustrating a digital display operation of the digital pressure gauge of FIG. 1; and

FIG. 5 is a front plan view of the digital pressure gauge of FIG. 1 connected to a compressor.

### DETAILED DESCRIPTION

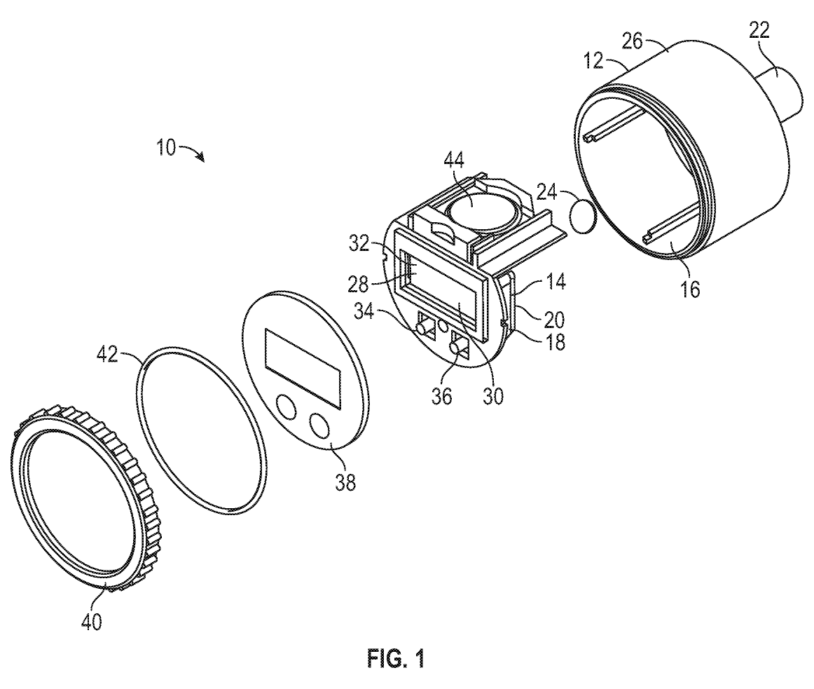

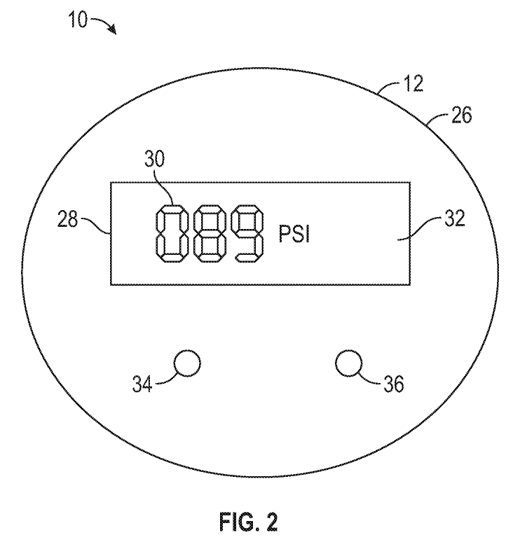

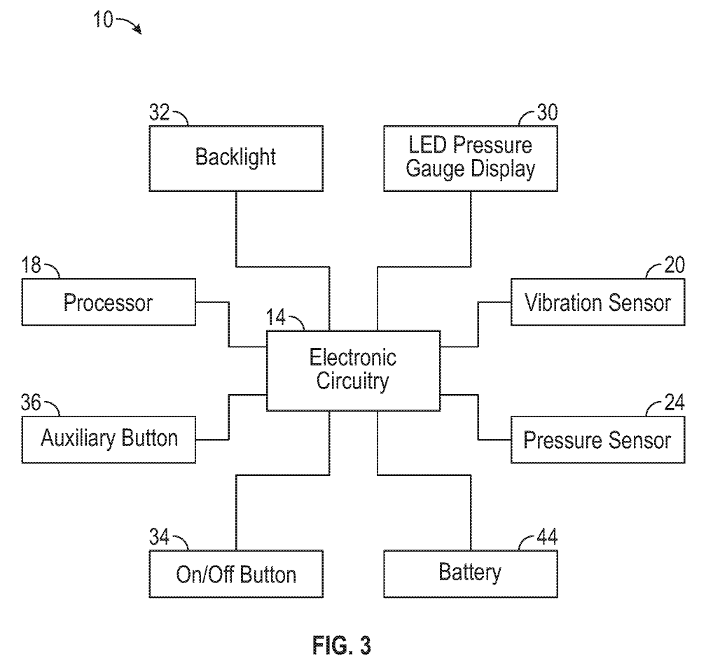

Referring now to FIGS. 1-3, in which the components are shown schematically and not to scale, a digital pressure gauge is generally designated 10 and includes a housing 12 for enclosing electronic circuitry 14 housed within a cavity 16 defined by the housing which accommodates and communicates with a processor 18. Preferably, the electronic circuitry 14 is in the form of a circuit board. The processor 18 receives data from the electronic circuitry 14 and processes the data to provide outputs.

Also within the cavity 16 is a vibration sensor 20, which is electrically connected to the electronic circuitry 14, and which detects vibrations caused by a source of air, such as a compressor (not shown in FIG. 1), to which the digital pressure gauge 10 is connected. While the vibration sensor 20 is preferably a g-sensor, it is appreciated that other alternative vibration sensors are contemplated as are known in the art. The sensitivity of the vibration sensor 18 is calibrated to detect a particular magnitude of vibration or greater.

The housing 12 also includes an inlet 22 which is fluidly connected to the source of air, and a pressure sensor 24 disposed inside the housing 12 proximate to the inlet 22, which measures a pressure value at the inlet. The pressure sensor 24 is electrically connected to the electronic circuitry 14, and relays the pressure value to the electronic circuitry. In a preferred embodiment, the inlet 22 is optionally disposed at different locations upon an exterior surface 26 of the housing 12.

The digital pressure gauge 10 also includes a digital display 28 which preferably displays the pressure value measured by the pressure sensor 24. In a preferred embodiment, the digital display 28 includes an LED display 30 and a backlight 32, the operation of which will be described in greater detail below. The LED display 30 and the backlight 32 are electrically connected to the electronic circuitry 14.

In a preferred embodiment, the digital pressure gauge 10 includes an on/off button 34 and an auxiliary button 36. The on/off button 34 allows a user of the digital pressure gauge 10 to manually turn the digital display 28 on and off. Preferably, the auxiliary button 36 allows the user to adjust the measurement unit displayed on the digital display 28. For example, if the digital display 28 is displaying the pressure value in PSI, the user optionally presses the auxiliary button 36 to change the units to Pascals or N/m².

Preferably, a cover 38, which is disposed over the digital display 28, the on/off button 34, and the auxiliary button 36, is made of any suitably resilient material as is known in the art. Further, a bezel 40 retains the electronic circuitry 14 and the cover 38 in place within the housing 12. In an example embodiment, the bezel 40 threadingly engages with the housing 12; however, other interlocking mechanisms are contemplated as are known in the art. A seal 42 is optionally used between the bezel 40 and the housing 12. In an embodiment, the housing 12 includes an internal battery 44, which is preferably a disposable battery.

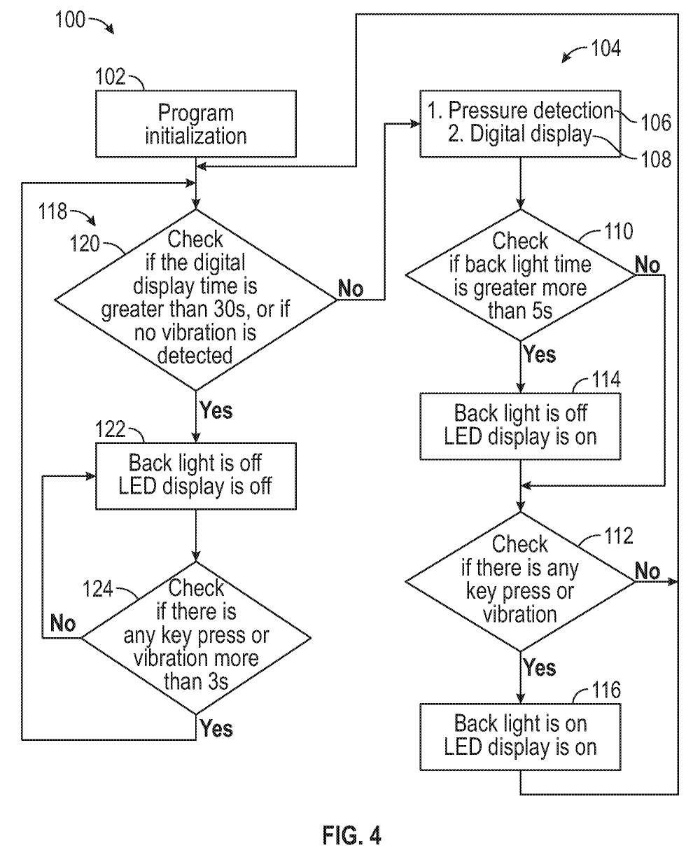

Referring now to FIG. 4, the electronic circuitry 14, which communicates with the processor 18, is configured to execute a digital display operation 100 that preferably includes a program initialization step 102 and a backlight deactivation protocol 104. The program initialization step 102 includes a user actuating the on/off button 34 of the digital pressure gauge 10, which turns the digital pressure gauge on.

The backlight deactivation protocol 104 preferably includes a pressure value measuring step 106 of measuring the pressure value at the inlet 22 with the pressure sensor 24. Preferably, the pressure sensor 24 is fluidly connected to a source of air via the inlet 22. After the pressure value measuring step 106, a display step 108 includes displaying the measured pressure value on the digital display 28 with the LED display 30. During the pressure value measuring step 106, the backlight 32 is also active.

Following the digital display step 108, a blacklight monitoring step 110 includes monitoring whether the backlight 32 has remained on for a predetermined backlight time period. When the backlight monitoring step 110 determines that the backlight 32 has remained on for a period of time less than the predetermined backlight time period, the digital display operation 100 proceeds to an activation detection step 112 of detecting whether an activation has occurred. Preferably, the activation includes either detection by the vibration sensor 18 of the vibration experience by the housing 12 or actuation of the on/off button 34. Alternatively, when the backlight monitoring step 110 determines that the backlight 32 has remained on for the predetermined backlight time period, the digital display operation 100 proceeds to a backlight deactivation step 114 of deactivating the backlight 32. While the predetermined backlight time period is preferably five seconds, alternate durations of the predetermined backlight time period are contemplated.

After the backlight deactivation step 114, the digital display operation 100 repeats the activation detection step 112. When the activation detection step 112 detects the activation, the digital display operation 100 proceeds to a backlight activation step 116 of activating the backlight 32.

The digital display operation 100 preferably includes an LED deactivation protocol 118 which includes an LED display monitoring step 120 of monitoring whether the LED display 30 has remained on for a predetermined LED display time period.

When the LED display monitoring step 120 determines that the LED display 30 has remained on for a period of time less than the predetermined LED display time period, and that no vibration has been detected, the digital display operation 100 proceeds to the backlight deactivation protocol 104. Alternatively, when the LED display monitoring step 120 determines that the LED display 30 has remained on for the predetermined LED display time period, and that no vibration has been detected, the method proceeds to an LED display deactivation step 122 of deactivating the LED display 30. While the predetermined LED display time period is preferably thirty seconds, alternate durations are contemplated.

After the LED display deactivation step 122, the digital display operation 100 proceeds to an LED monitoring step 124 of periodically monitoring whether the activation is detected at intervals of a predetermined idle time period, where the predetermined idle time period is preferably three seconds. When the activation is not detected during the LED monitoring step 124, the LED display remains deactivated. Alternatively, when the activation is detected during the LED monitoring step 124, the digital display operation 100 proceeds to the LED light monitoring step 120.

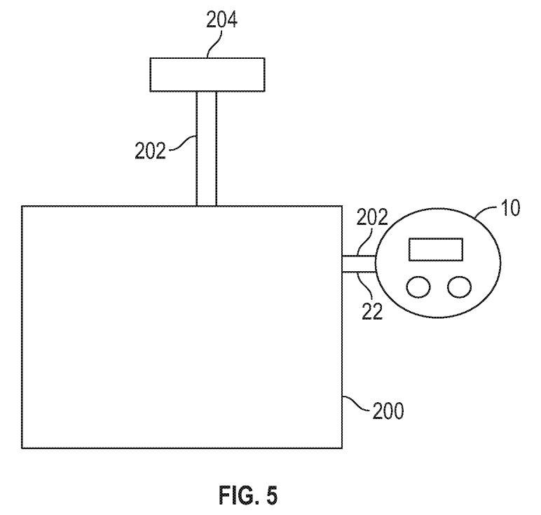

Referring now to FIG. 5, the digital pressure gauge 10 is connected to a compressor 200, such that the inlet 22 of the housing 12 is coupled to the compressor 200 via a conduit 202. The conduit 202 is optionally a hose or tube, as is known in the art. Additionally, the compressor 200 is connected to a tool 204 which receives compressed air from the compressor via a separate conduit 202.

While a particular embodiment of the present digital pressure gauge has been described herein, it will be appreciated by those skilled in the art that changes and modifications may be made thereto without departing from the invention in its broader aspects and as set forth in the following claims.

1. A digital pressure gauge, comprising:
a housing with an inlet port configured to receive air from a source of air;
a pressure sensor which measures a pressure value of the air at said inlet;
a digital display which displays the pressure value, said digital display including an LED display and a backlight which illuminates said LED display;
a vibration sensor which detects a vibration experienced by said housing;
an on/off button which turns said digital display on and off; and
electronic circuitry which communicates with a processor within said housing and which is electrically connected to said digital display, said pressure sensor, said on/off button, and said vibration sensor, said electronic circuitry being configured to execute a backlight deactivation protocol.

2. The digital pressure gauge of claim 1, wherein said backlight deactivation protocol comprises:
measuring said pressure value with said pressure sensor;
displaying said measured pressure value on said digital display; and
determining whether said backlight has remained on for a predetermined backlight time period, such that said backlight is deactivated when said backlight has remained on for the predetermined backlight time period.

3. The digital pressure gauge of claim 2, wherein said backlight deactivation protocol further comprises detecting whether an activation has occurred when said backlight has remained on for a period of time less than the predetermined backlight time period, said activation including either, detection by said vibration sensor of the vibration experience by said housing or actuation of said on/off button, and wherein said electronic circuitry measures said pressure value when said activation is detected.

4. The digital pressure gauge of claim 3, wherein said electronic circuitry is configured to execute an LED deactivation protocol, wherein said LED deactivation protocol comprises:
monitoring whether said LED display has remained on for a predetermined LED display time period, such that when said LED display has remained on for a period of time less than the predetermined LED display time period or said activation is detected, said electronic circuitry executes said backlight deactivation protocol, and when said LED display has remained on for the predetermined LED display time period, and said activation is not detected, said LED display is deactivated.

5. The digital pressure gauge of claim 4, wherein said LED deactivation protocol further comprises periodically monitoring for said activation at intervals of a predetermined idle time period, such that when said activation does not occur within the predetermined idle time period, said LED remains deactivated, and when said activation does occur, said electronic circuitry executes said backlight deactivation protocol.

6. The digital pressure gauge of claim 5, wherein the predetermined LED display time period is greater than the predetermined active time period.

7. The digital pressure gauge of claim 5, wherein the predetermined LED display time period is less than the predetermined idle time period.

8. The digital pressure gauge of claim 1, further comprising a disposable battery within said housing which powers said LED display, said backlight, said processor, and said electronic circuitry.

9. The digital pressure gauge of claim 1, further comprising an auxiliary button which changes a unit system displayed on said digital display.

10. A compressor system, comprising:
a compressor which produces pressurized air; and
a digital pressure gauge, comprising:
a housing with an inlet port configured to receive air from said compressor;
a pressure sensor which measures a pressure value of the air at said inlet;
a digital display which displays the pressure value, said digital display including an LED display and a backlight which illuminates said LED display;
a vibration sensor which detects a vibration experienced by said housing;
an on/off button which turns said digital display on and off; and
electronic circuitry which communicates with a processor within said housing and which is electrically connected to said digital display, said pressure sensor, said on/off button, and said vibration sensor, said electronic circuitry being configured to execute a backlight deactivation protocol.

11. The compressor system of claim 10, wherein said backlight deactivation protocol comprises:
measuring said pressure value with said pressure sensor;
displaying said measured pressure value on said digital display; and
determining whether said backlight has remained on for a predetermined backlight time period, such that said backlight is deactivated when said backlight has remained on for the predetermined backlight time period.

12. The compressor system of claim 11, wherein said backlight deactivation protocol further comprises detecting whether an activation has occurred when said backlight has remained on for a period of time less than the predetermined backlight time period, said activation including either, detection by said vibration sensor of the vibration experience by said housing or actuation of said on/off button, and wherein said electronic circuitry measures said pressure value when said activation is detected.

13. The compressor system of claim 12, wherein said electronic circuitry is configured to execute an LED deactivation protocol, wherein said LED deactivation protocol comprises:
monitoring whether said LED display has remained on for a predetermined LED display time period, such that when said LED display has remained on for a period of time less than the predetermined LED display time period or said activation is detected, said electronic circuitry executes said backlight deactivation protocol, and when said LED display has remained on for the predetermined LED display time period, and said activation is not detected, said LED display is deactivated.

14. The compressor system of claim 13, wherein said LED deactivation protocol further comprises periodically monitoring for said activation at intervals of a predetermined idle time period, such that when said activation does not occur within the predetermined idle time period, said LED remains deactivated, and when said activation does occur, said electronic circuitry executes said backlight deactivation protocol.

15. The compressor system of claim 14, wherein the predetermined LED display time period is greater than the predetermined active time period.

16. The compressor system of claim 14, wherein the predetermined LED display time period is less than the predetermined idle time period.

17. The compressor system of claim 10, further comprising a disposable battery within said housing which powers said LED display, said backlight, said processor, and said electronic circuitry.

18. The compressor system of claim 10, further comprising an auxiliary button which changes a unit system displayed on said digital display.
